(19) United States
(12) Patent Application Publication
(10) Pub. No.: US 2019/0154103 A1
(43) Pub. Date: May 23, 2019

(54) Hydraulic Shock Absorber Equipped With A leading Stop Having An Adjustable Braking Rule

(71) Applicant: PSA AUTOMOBILES S.A., Poissy (FR)

(72) Inventor: Antonin GROUL, Vaux sur Seine (FR)

(73) Assignee: PSA Automobiles S.A., Poissy (FR)

(21) Appl. No.: 16/091,166

(22) PCT Filed: Mar. 9, 2017
(86) PCT No.: PCT/FR2017/050520

§ 371 Date: Oct. 4, 2018

(30) Foreign Application Priority Data
Apr. 8, 2016 (FR) 1653132

(51) Int. Cl. F16F 9/49; B60G 13/08; F16F 9/346; F16F 9/19; F16F 13/00; B60G 17/08

(52) U.S. Cl. CPC F16F 9/49; B60G 13/08; F16F 9/346; F16F 9/19; B60G 15/061; B60G 17/08; F16F 2222/12; F16F 2228/066; B60G 2500/10; F16F 13/007

(57) ABSTRACT

A hydraulic shock absorber equipped with a leading stop, comprising a piston (4) sliding inside a body (2) for the purpose of shock absorption. The piston (4) moves a sleeve (10) which is disposed towards the front and provided with axially-distributed holes (18), and, at the shock absorber end-of-stroke, the sleeve fits around a stationary chamber (12) that gradually closes the holes (18), thereby reducing the cross-section through which fluid can flow into the sleeve (10). The chamber (12) comprises additional holes (40a, 40b) and said chamber (12) receives a moving gate (42) therein, which, depending on its position, either closes or opens the additional holes (40a, 40b).

### CROSS-REFERENCE TO RELATED APPLICATIONS

This application is filed under 35 USC § 371 to continue International App. No. PCT/FR2017/050520 which claims priority to French App. No. 1653132 filed on Apr. 8, 2016, both of which are incorporated herein by reference.

### BACKGROUND

The present invention relates to a hydraulic shock absorber with a leading stop, as well as an automotive vehicle equipped with such a shock absorber.

Automotive vehicles generally include, for each wheel, a suspension including a suspension spring, a shock absorber that brakes movement of the suspension, and a leading stop with which the frame comes into contact when the suspension reaches the end of its stroke in order to stop this movement while avoiding an impact.

A known type of hydraulic stop that may be integrated into a shock absorber, presented in particular FR2902850, includes the end of a jack shaft including a piston that descends before the end of its stroke into an internal tube fit into an external tube. The assembly is contained in a body filled with a fluid.

The external tube includes a control located on the exterior of the body, allowing it to rotate around its main axis. The internal and external tubes present a series of bores disposed axially, that according to the angular position of the external tube may be fully aligned with each other in order to allow maximum passage of the fluid, or gradually unaligned in order to reduce the passage of this fluid.

There is a hydraulic end of stroke stop presenting increasingly great braking force as a function of the advancement of the piston closing an increasing number of axially disposed bores. The more the adjustment of the angular position of the external tube provides different braking rules, which may in particular be relevant in the case of a shock absorber for an automotive vehicle to adapt these rules as a function of the load of the vehicle.

However, certain hydraulic shock absorbers have a different structure, comprising one piston of a primary shock absorber connected to a shaft sliding in an external body, including limited fluid passages to brake the movement of this primary shock absorber.

A leading hydraulic stop includes on the forward side in the compression direction of the shock absorber, a sleeve extending the piston and presenting a series of bores disposed axially, which are positioned around a stationary chamber before the end of stroke.

The annular volume between the body and the chamber is therefore reduced by the axial advancement of the sleeve, which forces the fluid contained within this annular volume towards the internal volume of the sleeve through its axially disposed bores, which increasingly brake the piston through their gradual closures. The fluid then passes from the rear side of the piston through the limited passages of this piston.

There is therefore a problem to construct, in a simple and effective manner with this type of leading stop structure including bores disposed on the sleeve which is mobile, an adjustment system providing various braking rules for this stop.

### BRIEF SUMMARY

The present invention in particular is intended to avoid these disadvantages of the prior art.

To this end a hydraulic shock absorber is disclosed which is equipped with a leading stop, and including a piston that slides into a body to absorb the shock, with this piston moving a sleeve positioned forward, that has bores disposed axially, with this sleeve at the end of stroke of the shock absorber fitting around a fixed chamber that gradually closes these bores by reducing the cross-section for fluid passage towards the interior of the sleeve. This shock absorber is noteworthy due to the fact that the chamber has additional bores, and by the fact that this chamber internally receives a moving gate that, depending on its position, closes or opens additional bores.

One advantage of this shock absorber is that the jacket, being a stationary element, by providing top bores and equipping it inside with a moving gate on the interior, one may easily dispose a control on this gate connected to the outside to control it manually or automatically, or an internal control depending on the average position of the shock absorber piston, in order to easily make adjustments to this gate providing various braking rules for the leading stop.

The shock absorber may additionally comprise one or several of the following features, which may be combined with each other.

Advantageously, the gate has translational movement along the primary axis of the shock absorber, or rotates around this axis.

Advantageously, the chamber comprises more than two additional bores, which are gradually uncovered by the movement of the gate. In this manner one may obtain different braking rules for the leading stop.

According to one embodiment, the gate includes an internal control in the body of the shock absorber, not related to the exterior of this shock absorber.

In particular, the external control may include a motor.

According to another embodiment, the gate comprises an internal control in the body of the shock absorber, with no relation to the outside of that shock absorber.

In this case, the internal control may comprise a connection that is moved by the movements of the shock absorber piston, by applying force to the gate.

Advantageously, the internal control comprises a device for delaying or filtering the frequency of the movement of the gate.

According to one embodiment, the device for timing or filtering the movement of the gate comprises a slaved hydraulic damper comprising the gate forming a slaved piston moving in the chamber, and a calibrated nozzle forming a passage to this chamber.

According to another embodiment, the device for timing or filtering the movement of the gate includes inertia related to this gate comprising an inertial mass or a liquid column.

According to another embodiment, the device for timing or filtering the movement of the gate includes a calibrated hydraulic valve that opens for a load threshold applied above.

Also disclosed is an automotive vehicle including suspensions equipped with hydraulic shock absorbers having leading stops, including any one of the previous features.

### DESCRIPTION OF THE FIGURES

The claimed invention will be better understood and other features and benefits will appear more clearly from reading the following description provided by way of example and without limitation, with respect to the attached drawings, in which:

FIGS. 1a and 1b are axial section views of a prior art hydraulic leading stop, presented respectively before the work of this stop and during its work;

FIG. 2 is a graph showing the force applied by this leading stop as a function of its stroke for various speeds;

FIG. 3 is an axial section view of a variant of the prior art leading stop;

FIGS. 4a and 4b are axial sectional diagrammatic views of a leading stop including two additional bores, presented respectively in a position of light braking and strong braking;

FIG. 5 is a diagram presenting a side view of a variant of the leading stop showing a series of additional bores in the chamber of this leading stop;

FIGS. 6a and 6b are drawings presenting transverse section views of two positions of the moving gate for the variant of FIG. 5;

FIG. 7 presents a graph showing the cross-sections of the passage of fluid as a function of the piston stroke for the leading stop including two additional bores;

FIGS. 8a and 8b are axial sectional diagrammatic views of a leading stop including an internal control, presented respectively in a light braking and strong braking position; and

FIGS. 9, 10 and 11 are graphs prepared by simulations, presenting for the latter leading stop the movement of the gate for a quasi-static load change, the stroke of the piston of the primary shock absorber in dynamic state during the movement of the vehicle, and the movement of the gate during this vehicle movement.

### DETAILED DESCRIPTION

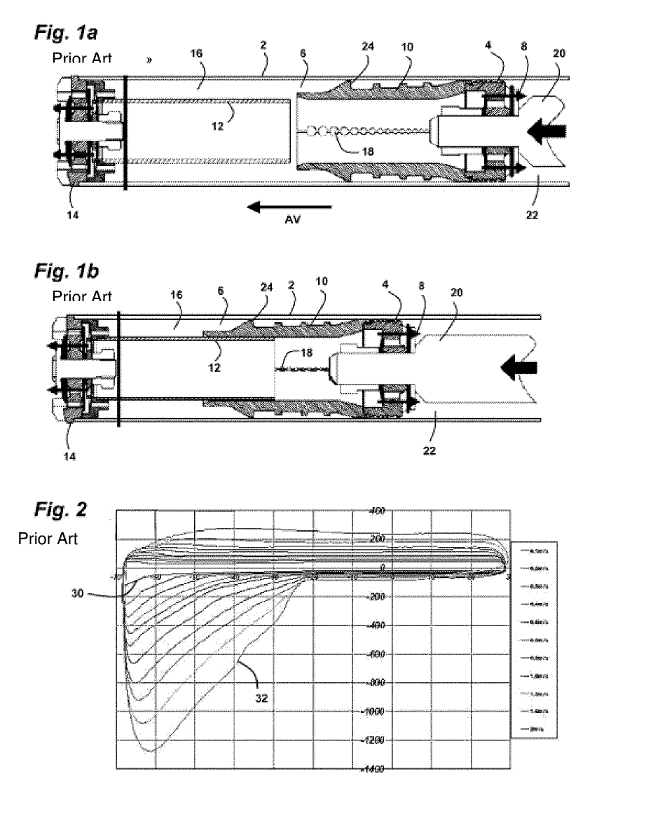

FIG. 1a presents a shock absorber comprising an external cylindrical body 2 containing a piston 4 mounted at the end of a damper shaft 20, sliding into this body with a seal to delimit a forward volume 6 and a rear volume 22. The piston 4 comprises reduced fluid bores 8 between the two forward 6 and rear 22 volumes that brake its movement as a function of the speed of fluid passage, and therefore the speed of this piston.

The piston 4 extends from the forward side indicated by the arrow “AV”, by a circular sleeve 10 provided to slide into an annular volume 16 around a cylindrical chamber 12 of a leading hydraulic stop, before the end of stroke of this piston. The hydraulic chamber 12 forms a hollow tube, at its forward end mounted to an end cover 14 enclosing the body 2 from the forward side.

The sleeve 10 includes an annular boss 24 that guides it in the outer body 2, and a series of radial bores 18 that are axially aligned, that present a decrease in diameter from the front to the rear.

Upon arrival of the sleeve 10 around the chamber 12 presented FIG. 1b, the bores 18 are gradually closed as a function of the advancement of the piston 4, which increasingly reduces the total cross-section of front fluid volume passage towards the interior of this sleeve. The fluid then passes from the interior of the sleeve 10 towards the rear volume 22 through the reduced bores 8 of the piston 4.

Gradually increasing braking of the shock absorber shaft 20 is obtained, depending on the position of the piston 4, that may be controlled by adjusting the diameters and the positions of the bores 18 in the sleeve 10.

FIG. 2 presents a graph showing the braking force of the leading stop expressed in daN on the vertical axis, as a function of its stroke expressed in millimeters, for varying stroke speeds of the piston 4. For each speed there is a stroke start of the leading stop at −20 mm, then an increasing braking force of that stop that comes from the gradual closure of the bores 18.

In particular for a low speed presented by the curve 30 which is 0.1 m/sec., a maximum braking force of approximately 100 daN is obtained. For a high speed presented by the curve 32 which is 2 m/sec., a maximum braking force of 1300 daN is obtained.

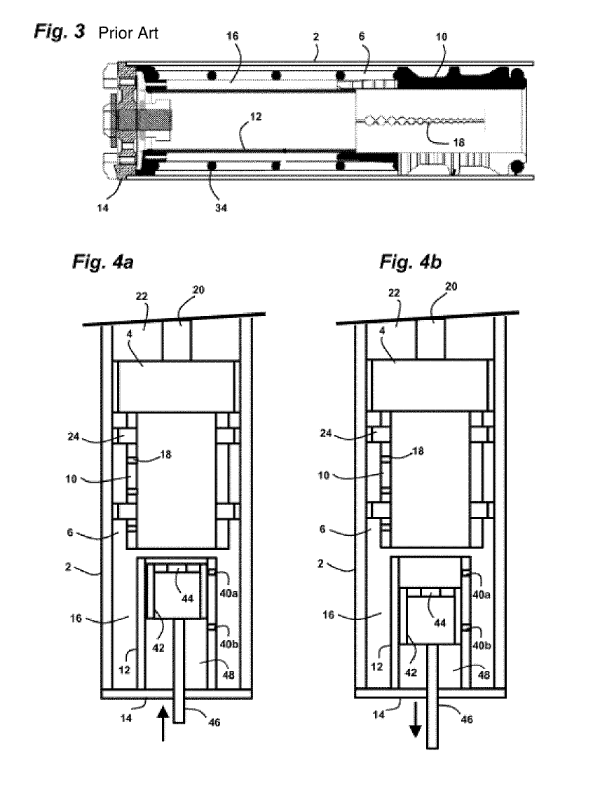

FIG. 3 presents a sleeve 10 detached from the piston, which when this piston is placed in a rest position in which it is just engaged at the start of the chamber 12, by a spiral positioning spring 34 disposed in the forward volume 6 and attached to the end cover 14. In this manner, the shock absorber may travel normally without moving the sleeve 10 which remains in its rest position.

During a significant stroke of the shock absorber, the piston 4 coming near the end of its stroke presses on the sleeve 10 compressing the positioning spring 34, which reduces the forward volume 6 by assuring the braking of this piston.

FIG. 4a presents a variant of the leading stop presented FIG. 1a, including additional radial bores 40a, 40b formed in the chamber 12 at various axial distances, and a gate 42 set in this chamber, that may, depending on its height, plug certain additional bores.

The interior volume 48 of the chamber 12 is permanently connected to the forward volume 6 of the shock absorber by an axial bore 44 of the gate 42.

The gate 42 is connected to the outside by an external control 46 that traverses the end cover 14, to be moved axially by a control that is manual or automatic.

In the position of the gate 42, presented in FIG. 4a, when the sleeve 10 contacts the chamber 12 an additional passage for the fluid is obtained from the forward volume 6 to the interior of this sleeve via the lower additional bore 40b that is disposed more forward. The primary shock absorber has significant travel with the lower additional bore 40b remaining open, which provides slight braking of this shock absorber.

In the position of the gate 42, presented in FIG. 4b, the external control 46 having been activated to drop this gate, only the upper additional bore 40a is open. The primary shock absorber has a short stroke with the upper additional bore 40a remaining open, then the sleeve 10 covers this bore and closes it quickly which provides significant braking of this shock absorber that occurs more quickly.

It is thus possible via an easy to activate external control 46 due to the stationary chamber 12 that allows only a small movement of the gate 42 to be applied, to control the braking force of the leading stop. In particular the external control 46 may comprise externally a control via axial slide, or by a screw-nut system that allows rotation to be applied to a shaft protruding from the shock absorber.

These movements may be applied manually, in particular as a function of the weight of the vehicle to set the leading stop when the vehicle is more loaded, or by a motor that can be actuated by manual control or automatically by reacting for example as a function of the information given by sensors indicating the load or the depression of the suspension.

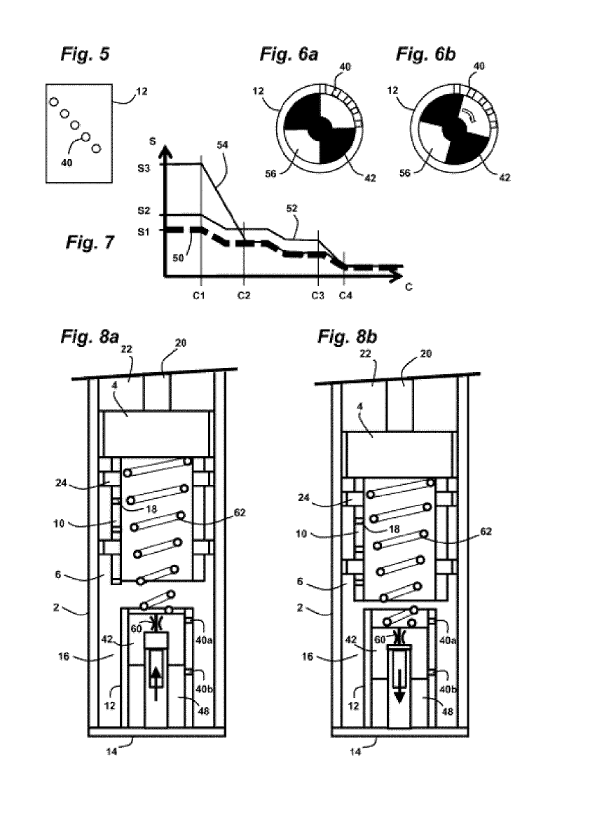

FIG. 5 presents a variant of the chamber 12 comprising a series of additional bores 40 disposed diagonally, with a simultaneous axial offset and a radial offset.

It may be noted that the axial distribution of the additional bores 40 may vary, and their diameters may also vary so as to obtain suitable braking rules for the leading stop.

FIG. 6a presents a gate 42 that rotates around the primary axis of the shock absorber, the gate 42 comprising two opposed recesses 56 that each extend over 90°. The external control 46 of this rotary gate 42 includes an axial shaft protruding from the end cover 14, which is rotary driven.

In the position presented FIG. 6a, with all the additional bores 40 that are in a recess 56, the maximum cross-section is provided for fluid passage that provides slight braking of the leading stop.

In the position presented FIG. 6b, slight rotation of the gate 42 closed the first additional bore 40 that is axially positioned the farthest forward, which provides stronger braking at the end of stroke of the leading stop. By continuing the rotation of the gate 42, the additional bores 40 are increasingly (sequentially) closed, which provides significant braking of the leading stop coming increasingly quickly.

FIG. 7 presents a graph for a leading stop comprising two additional bores 40 presented in FIG. 4a, the total passage cross-section S of the forward chamber 6 to the interior of the sleeve 10 as a function of the stroke C of the leading stop, which represents by reducing the braking level of this stop.

Curve 50 presents the passage cross-section of the single bores 18 of the sleeve 10, including at the start of compression stroke of the leading stop, the maximum cross-section S1 which is relatively small. Then there is gradual closure of the bores 18 in the sleeve 10 by bearings, to attain the closure of all these bores with the stroke C4.

Curve 52 presents the total passage cross-section including the bores 18 in the sleeve 10, and the additional lower bore 40b that remains completely open until the stroke C3 disposed slightly forward of the end of stroke of the leading stop, and that gradually closes until curve C4. Starting with an initial value S2, a cross-section that, until stroke C3, is increased by an additional constant value in relation to the bores 18 alone in the sleeve 10 represented by curve 50.

Curve 52 represents a braking rule for the leading stop for an empty vehicle, including average braking over the entire stroke.

Curve 54 presents the total passage cross-section including bores 18 in the sleeve 10, and the additional large diameter upper bore 40a which remains completely open until stroke C1 disposed slightly forward after the start of stroke of the leading stop.

A very significant cross-section S3 is obtained inasmuch as the upper additional bore 40a remains open, until stroke C1, then a gradual closure of this bore until stroke C2. Curve 54 at this point joins curve 50 for the single bores 18 in the sleeve 10.

Curve 54 presents a leading stop braking rule for a loaded vehicle including reduced braking at the start of stroke while the more depressed suspension works more commonly at this start of stroke, and towards the end of stroke very significant braking to avoid an impact at the end of stroke.

FIG. 8a presents a leading stop similar to that presented FIG. 4a, including a gate 42 forming a slaved piston enclosing the internal volume 48 of the chamber 12, disposing along its axis a calibrated timing nozzle 60 creating a significant flow limitation, establishing a limited connection between this internal volume and the forward volume 6 of the shock absorber. The gate 42 enclosing the internal volume 48 of the chamber 12 is a slaved shock absorber.

A spiral slave spring 62 disposed for the most part in the sleeve 10 is mounted at one end to the bottom of this sleeve and at the other end to the gate 42. The slave spring 62 transmits to the gate 42 information regarding the average position of the piston 4 of the primary shock absorber, to obtain the movement of this gate with delayed effect due to the very low flow rate passing through the timing nozzle 60 of the slave shock absorber.

When the piston 4 of the primary shock absorber is in an average high position as presented FIG. 8a, the gate 42 is also in its high position.

When the piston 4 of the primary shock absorber passes into an average lowest position presented FIG. 8b, with a delayed effect the thrust of the slave spring 62 causes the lowest position of the gate 42 to be obtained.

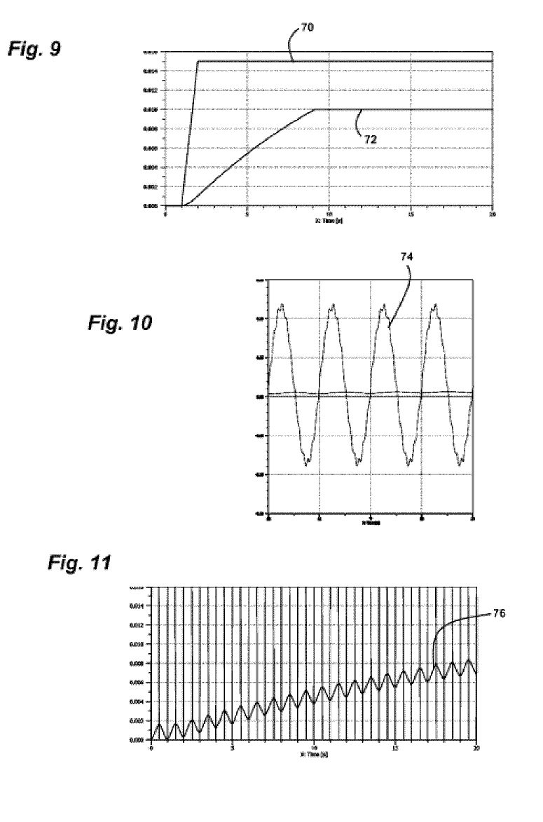

FIG. 9 presents axial movements expressed in meters on the vertical axis, as a function of time expressed in seconds.

Curve 70 presents an abrupt movement of the primary shock absorber along a stroke distance of 15 mm, produced for example with the arrival of a load on the vehicle that depresses the suspension. Curve 72 presents the movement of the gate 42 in response, due to the effect of the slave spring 62 conveying force to this gate, and of the slave shock absorber. The total stroke of the gate 42 of 10 mm ends after a period of 8 seconds.

It will be noted that the internal control of the gate 42 by the slave spring 62 is passive, using no energy or control external to the shock absorber.

FIG. 10 presents, as a function of time expressed in seconds, a curve 74 showing movement of the primary shock absorber comprising an oscillation with a total amplitude of approximately 200 mm and a period of one second.

FIG. 11 presents a curve 76 showing, for the superimposition of the abrupt movement of the average position of the primary shock absorber presented in FIG. 9 with the oscillation presented FIG. 10, as a function of time expressed in seconds, the resulting movement of the gate 42.

One will note the slow movement of the gate 42 with the vehicle loaded, to reach its displaced balanced position of 10 mm, in which a faster oscillation is superimposed with a period of one second presenting a low amplitude of less than 2 mm. One may consider that this quick oscillation will change the behavior of the leading stop little, while the slow movement of the gate 42 after a few seconds yields a substantial change to the braking rule of that stop, to correspond to the new load of the vehicle.

One may envision a slave spring 62 mounted on both ends to exert traction and compression simultaneously, or on a single end or neither end to only exert compression. In the latter cases, the slave spring 62 may work only on an end part of the stroke of the primary shock absorber.

In addition, one may dispose an additional slave compression spring in the internal volume 48 of the chamber 12, in particular to apply axial force upward on the gate 42 which is added to that of a main slave spring 62 exerting compression and applying downward force on this gate.

Additionally one may dispose an inertial mass on the gate 42 in order to make its movement less sensitive to oscillations at a higher frequency of piston 4 of the primary shock absorber, in order to create a system to delay its movement. One may also attach a liquid column to the movement of the gate 42, with the liquid mass forming an inert.

In a variant, one may use a device for timing or filtering the movement of the gate 42 including a calibrated hydraulic valve that opens for a load threshold being applied to it, given for example by the pressure of the slave spring 62.

Thus one achieves in a simple and economical manner an internal control of the leading stop rule that avoids manual intervention for adjustment as a function of the load of the vehicle, or an electrical installation in this vehicle to control a commanded automatic actuation.

1. A hydraulic shock absorber equipped with a leading stop, including a piston sliding in a body to achieve a dampening, the piston displacing a sleeve disposed toward the front, the sleeve having axially disposed bores, the sleeve, at the end of stroke of the shock absorber, fitting around a fixed chamber that gradually closes the bores by reducing the passage cross-section of the fluid towards the interior of the sleeve, wherein the chamber comprises additional bores, and in that this chamber internally houses a movable gate that, depending on its position, closes or opens the additional bores.

2. The hydraulic shock absorber according to claim 1, wherein the gate presents translational movement along the primary axis of the shock absorber, or rotational movement around this axis.

3. The hydraulic shock absorber according to claim 1, wherein the chamber comprises more than two additional bores which are gradually uncovered by the movement of the gate.

4. The hydraulic shock absorber according to claim 1, wherein the gate includes an external control that may be actuated from the outside of the body of the shock absorber.

5. The hydraulic shock absorber according to claim 4, that wherein the external control comprises a motor.

6. The hydraulic shock absorber according to claim 1, wherein the gate comprises an internal control in the body of the shock absorber, not related to the exterior of this shock absorber.

7. The hydraulic shock absorber according to claim 6, wherein the internal control comprises a connection moved by the movements of the piston of the shock absorber, applying force to the gate.

8. The hydraulic shock absorber according to claim 6, wherein the internal control includes a device for timing or filtering the frequency of movement of the gate.

9. The hydraulic shock absorber according to claim 8, wherein the device for timing or filtering the movement of the gate comprises a slave hydraulic shock absorber including the gate forming a slave piston moving in the chamber, and a calibrated nozzle forming a passage into that chamber.

10. The hydraulic shock absorber according to claim 8, wherein the device for timing or filtering the movement of the gate includes an inertia linked to this gate including an inertial mass or a column of liquid.

11. The hydraulic shock absorber according to claim 8, wherein the device for timing or filtering the movement of the gate includes a calibrated hydraulic valve that opens for a load threshold applied to it.

12. An automotive vehicle including suspensions equipped with hydraulic shock absorbers according to claim 1.
